(19) United States
(12) Patent Application Publication
(10) Pub. No.: US 2013/0087747 A1
(43) Pub. Date: Apr. 11, 2013

(54) Quantum Confined Thermoelectric Compositions

(71) Applicant: Evident Technologies, Troy, NY (US)

(72) Inventors: Clinton T. Ballinger, Burnt Hills, NY (US); Susanthri Perera, Cohoes, NY (US); Adam Z. Peng, Schenectady, NY (US)

(73) Assignee: EVIDENT TECHNOLOGIES, Troy, NY (US)

(21) Appl. No.: 13/644,778

(22) Filed: Oct. 4, 2012

Related U.S. Application Data
(60) Provisional application No. 61/544,426, filed on Oct. 7, 2011.

(51) Int. Cl. H01B 1/02

(52) U.S. Cl. CPC H01B 1/02
USPC 252/519.4

(57) ABSTRACT

Embodiments of the invention relate generally to nanocrystal compositions of matter. In one embodiment, the invention provides a composition comprising: a matrix material; and a plurality of quantum confined semiconductor nanocrystals embedded in the matrix material, wherein the composition has a first grain size of less than approximately 500 nm.

### CROSS-REFERENCE TO RELATED APPLICATIONS

This application claims the benefit of co-pending U.S. Provisional Application Ser. No. 61/544,426, filed 7 Oct. 2011, which is hereby incorporated by reference herein.

### FIELD OF THE INVENTION

Embodiments of the invention relate generally to a composition of, and a method of making, nanostructured materials from semiconductor nanocrystals in order to control the electronic properties of the aggregate material.

### BACKGROUND OF THE INVENTION

The electronic, thermal, and mechanical properties of materials are interdependent upon each other in what is sometimes a complicated way. For example, materials with a high thermal conductivity are typically very good electrical conductors as well. Due to this interdependency, it can also be difficult to separate these fundamental material properties from one another. Methods, such as molecular beam epitaxy (MBE), are sometimes used to construct layered materials in an attempt to create a composite material with different properties between the constituent parts. However, materials that are grown via MBE are typically very thin and expensive to produce.

Colloidally grown semiconductor nanocrystals, or quantum dots, have been studied for years but have not seen widespread use in applications, especially in electronic applications. One of the major drawbacks of using colloidally grown quantum dots is that they are grown in a solution and have persistent surface ligands, as an artifact and often necessity of synthesis, which can be very difficult to clean from the quantum dots. The number of surface molecules on each surface of a quantum dot can impact the final electronic properties of the material and may act as an unwanted contaminant. However, if the nanocrystals can be cleaned sufficiently or the remaining surface ligands can be useful in a final material, then nanocrystals may hold a lot of promise for tuning the properties, including the electronic properties, of materials.

To date quantum dots have largely been used as individual fluorescing materials in which each individual quantum dot functions individually, rather than through interaction with a multitude of quantum dots in order to form a resultant material. Examples such as quantum dot phosphors and fluorescing biotechnology reagents use the individual properties of quantum dots.

### SUMMARY OF THE INVENTION

A first aspect of the present invention includes a composition comprising: a matrix material; and a plurality of quantum confined semiconductor nanocrystals embedded in the matrix material, wherein the composition has a first grain size of less than approximately 500 nm.

A second aspect of the present invention includes a method of making a composition, the method comprising: mixing a matrix material and a plurality of quantum confined semiconductor nanocrystals; and consolidating the mixture, wherein the composition of material has a first grain size of less than approximately 500 nm.

### DETAILED DESCRIPTION OF THE INVENTION

Embodiments of the invention utilize certain aspects and properties of quantum dot materials, combined with other materials to obtain a composite material that has novel electronic properties. Colloidally grown quantum dots are inherently more scalable and cost efficient than MBE grown materials, thus allowing this approach to be useful for commercial applications.

Mechanically milled semiconductor materials can sometimes be physically altered until they reach the nanometer (nm) size regime. However, these materials typically cannot be milled small enough to reach the quantum confinement regime and they almost always have broad distributions in sizes of the nanometer sized resultant product. The quantum confinement regime is a unique range in size of particles that results in the material exhibiting different material properties than those of the bulk material. This size regime is unique in that the exciton Bohr radius of the material is larger than the physical dimensional radius of the resulting material. The Bohr radius is an inherent property of the material defined with respect to the bulk material and is typically less than tens of nanometers. Milled materials are typically greater than 100 nm or so in radius. As understood in the art, the radius refers to at least one dimension, typically the smallest dimension, of a resulting material.

Nanoparticles, as discussed in embodiments below, are typically controlled by their smallest dimension, as well. For instance, a 100 nm rod shaped nanoparticle that is 10 nm in diameter will typically exhibit quantum confinement effects, with respect to the 10 nm diameter rather than the longer length of the particle.

The grain size of a final composite material impacts both the electrical and thermal properties, as well as the mechanical properties. The final grain size is typically a function of the starting material. Various factors of the starting material that can affect the grain size include the size of the material used at the beginning, the heating history, the pressures used, and other relevant processes applied to the material. Typically, when a powdered material is consolidated into a single, monolithic material, heat and pressure are applied to the starting material. For instance, grain sizes in bulk BiₓSb₍₂₋ₓ₎Te₃ materials, for example, where x is approximately 0.5, are on the order of hundreds of micrometers. There are numerous reports in the literature that show grain sizes of greater than 10 micrometers in material that started from bill milled powders. However, starting with nanocrystals can result in a grain size of nanometers, tens of nanometers, or hundreds of nanometers. Hot pressing and Spark Plasma Sintering are examples of processes used for making such a material, as well as cold pressing with an annealing step and casting techniques, though not an exhaustive list of processes possible. The grains of the material do not get smaller in such a consolidation process, although they may get larger through the process as particles merge. Accordingly, the smaller the grain size of the starting material, the greater the range of grain sizes possible in the final material.

The density of states in the material is typically thought of as a bulk material property. In embodiments of the current invention, however, the density of states is considered an isolated property that has an impact on the aggregate material properties. Even though this composite material is electrically connected throughout, the regions of semiconductor nanocrystals still retain some of their nanostructured quantum confinement properties and hence impact the density of electron states throughout the material.

Small grain sizes, for instance less than about 500 nm, can lead to a narrowing of the density of possible electron states and may lead to a filtering of electrons with respect to energy. The more grain boundaries, and thus the smaller the grain size, there are in a material, the more pronounced this energy filtering property can manifest, especially within heterogeneous materials. Each time an electron goes from one grain to another, it has to jump a certain energy barrier. These barriers have a variety of energies associated with them as they may be the result of a physical gap, contamination between grains, heterogeneous materials between grains, or in some cases, even a different lattice orientation from one grain to another. The current invention capitalizes on this property, in some embodiments, due to the small grain size. The beginning grain size may be the same size as the diameter of colloidally grown quantum dots, making them on the order of tens of nanometers, or in some embodiments, only a few nanometers. Hence, materials according to the present invention can open the possibility of very pronounced electron filtering with respect to energy of the transport electrons in addition to a very low density of electronic states.

With the electron filtering due to grain size and control over the density of states, an enhanced Seebeck coefficient can be achieved and the resultant composite material has properties that are controllable beyond the scope of previous material systems, such as those of bulk material systems.

In one embodiment, these materials may have compelling tunable properties, especially for thermoelectric applications. The disclosed material may consist of multiple alternating layers of large grains and small grains, for example. In a thermoelectric device, electrons tend to migrate from the hot side of the device to the cooler region, and given the structure disclosed, they may not be as likely to migrate back to the hot side of the device with careful use of grain sizes throughout the device. This can enhance the Seebeck coefficient of the resulting material and lead to a profound increase in the overall thermoelectric efficiency.

In some embodiments, this can be accomplished by having a plurality of layers, each perpendicular to the electron current, that are of varying grain size. Variations can include grain sizes anywhere between about 2 nm and about 500 nm, or more particularly between about 10 nm and about 100 nm. Each layer can have a distinct grain size, or grain sizes may repeat periodically, such as every other layer. In further embodiments, these layers may include various doping concentrations within each of the plurality of layers. Dopants can include electron donor type materials that have an additional electron in their valance shell, such as P, As, Sb, and other group V elements, as well as many other traditional materials for doping group IV materials. Likewise, Group III materials will act as acceptor dopants for group IV materials and include materials such as Boron, aluminum, etc. Dopants are dependent on the semiconductor they are being used to dope. For example, Sn may be an acceptor dopant for one semiconductor and a donor dopant for another semiconductor. Hence, there are many possibilities and combinations of dopants that can alter or affect the charge carrier dynamics of each particular semiconductor.

In further embodiments, the plurality of layers may utilize different material systems, for instance different types of quantum dots, also referred to as semiconductor nanocrystals, different sizes of quantum dots, or different matrix materials. The process may utilize different amounts of impurity molecules between the grains, which may be included as residue from the colloidal nature of their growth. For instance, certain ligands may be left on the quantum dots, or partially left on the quantum dots, and incorporated into the layer of the final material. Each of these disclosed nanostructures may enhance the Seebeck coefficient, in part due to the electrons moving farther away from their birth site in the device and reducing the probability of them returning due to the heterogeneous structure.

In another embodiment, regions of nanocrystals are electrically connected to each other via a semiconductor interstitial matrix material, where dopants may be included inside the nanocrystal regions. By doping the nanocrystal regions rather than the matrix material between the nanocrystal regions, better electrical conduction properties may be achieved. The electrons will largely travel through the matrix material in such an embodiment. Dopants included inside the nanocrystal regions, however, can affect the charge carrier concentration without impeding electron transport as a defect or scattering site. Unlike traditional semiconductors, this structure may isolate the dopant atoms while still retaining the electronic benefit without contributing to a loss mechanism. In some embodiments, this can be accomplished in BiSbTe material systems, as one example, by utilizing BiTe nanocrystals doped with an appropriate atom, and a matrix material of SbTe. In addition, a further embodiment includes utilizing a material such as BiS nanocrystals as a dopant in addition to the above disclosed BiTe and SbTe materials. The isolated BiS can act as a donor without impeding the electrical propagation of the final composition. This is process is similar to traditional doping of a semiconductor lattice, however it is different in that nanocrystals that are donor or acceptors can be added to another nanocrystal material and act as the dopant even though they are not incorporated into a semiconductor lattice in the traditional sense.

In another embodiment, a method of making a material includes mixing the appropriate nano-sized semiconductors together as a dry powder. The final material may contain variations in grain size, composition, amount or types of dopant, and other similar variations.

In some embodiments, a grain growth inhibitor may be added to the nanocrystal powder or some portion of the starting material or layers. This grain growth inhibitor can decrease the end grain size of one or more layers of the material. Grain growth inhibitors may include, but are not limited to, tungsten, titanium, silver, oxygen, silicon, carbon and zirconium.

Another embodiment includes introducing a region to the material that may interrupt the electrical pathway via a barrier of relatively higher energy. This can have numerous effects, one of which is that it may preferentially filter the electrons that contribute to the transport process, which may only allow those with sufficiently high energy to contribute. In addition, this method makes for a more torturous pathway for electrons to propagate counter to a heat flux. In essence, this layer, in one example an oxide layer, can act as a gate to allow electrons to pass without letting them return, which enhances the Seebeck coefficient and helps to decouple the electrical conductivity from the Seebeck coefficient. Both of these effects can be largely beneficial for thermoelectric applications of the material.

The final material of certain embodiments may be formed by using a variety of non-conductive species or higher bandgap semiconductor materials distributed or included in regions of the final consolidated material. Examples include a region where the carbon contamination level is less than approximately 5000 ppm or where the final oxygen contamination level is less than approximately 5000 ppm. Additionally, the final material may include particles of nanometer size, for instance approximately 2 nm to 500 nm, while the overall size of the final material may be in the micrometer range, for instance, over approximately 500 micrometers, for simpler inclusion into existing systems, such as thermoelectric systems. In addition, the use of a grain growth inhibitor may be utilized in order to control and retain the nanometer sized grains of the starting materials in the final material system.

Further embodiments include methods of making these quantum confined compositions. For example, the various material compositions disclosed throughout may be produced in a variety of ways. Dry powders of the various materials, or dry powders of the atomic components of the various materials, including but not limited to semiconductor nanocrystals, matrix materials, grain growth inhibitors, and dopants, can be mixed together before a consolidation process, which may be chosen from any now known or later developed consolidation processes. This mixing can be accomplished via ball-milling, stirring, and mortar and pestle mixing, among others. These materials can also lend themselves to wet mixing techniques. For example, the semiconductor nanocrystals are typically synthesized via a colloidal chemistry approach. The desired dopants or other materials disclosed can be mixed into the colloidal solution to ensure a uniform distribution. This solution can be dried to form a powder that is homogeneously mixed to be consolidated subsequently.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A composition comprising:
a matrix material; and
a plurality of quantum confined semiconductor nanocrystals embedded in the matrix material, wherein the composition has a first grain size of less than approximately 500 nm.

2. The composition of claim 1, wherein the matrix material is a material capable of enhancing an electron energy filtering.

3. The composition of claim 1, wherein the matrix material has an electronic structure that isolates the embedded semiconductor nanocrystals.

4. The composition of claim 1, further including a dopant.

5. The composition of claim 4, wherein the dopant comprises at least one of group consisting of: a conductive dopant in at least one of the plurality of nanocrystals or the matrix material, a dopant in the plurality of nanocrystals, a dopant comprising a charge carrier in the matrix material, and a dopant in a set of grain boundaries of the composition.

6. The composition of claim 1, further including a grain growth inhibitor.

7. The composition of claim 1, further including at least a second plurality of quantum confined semiconductor nanocrystals embedded in the matrix material in a separate layer, wherein the separate layer has a second grain size which is different than the first grain size.

8. The composition of material of claim 7, wherein the at least a second plurality of quantum confined semiconductor nanocrystals is at least one of: a different material composition or a different size than the plurality of quantum confined semiconductor nanocrystals.

9. A method of making a composition, the method comprising:
mixing a matrix material and a plurality of quantum confined semiconductor nanocrystals; and
consolidating the mixture, wherein the composition of material has a first grain size of less than approximately 500 nm.

10. The method of claim 9, wherein the matrix material is a material capable of enhancing an electron energy filtering.

11. The method of claim 9, wherein the matrix material has an electronic structure that isolates the embedded nanocrystals.

12. The method of claim 9, further comprising:
mixing a dopant with the matrix material and the plurality of quantum confined semiconductor nanocrystals.

13. The method of claim 12, wherein the dopant comprises at least one of a group consisting of: a conductive dopant in at least one of the plurality of nanocrystals or the matrix material, a dopant in the plurality of nanocrystals, a dopant comprising a charge carrier in the matrix material, and a dopant in a set of grain boundaries of the composition.

14. The method of claim 9, further comprising:
mixing a grain growth inhibitor with the matrix material and the plurality of quantum confined semiconductor nanocrystals.

15. The method of claim 9, further comprising:
mixing a second plurality of quantum confined semiconductor nanocrystals with the matrix material in a separate layer, wherein the separate layer has a second grain size which is different than the first grain size.

16. The method of claim 15, wherein the second plurality of quantum confined semiconductor nanocrystals is at least one of: a different material composition or a different size than the plurality of quantum confined semiconductor nanocrystals.
